(19) United States
(12) Patent Application Publication
(10) Pub. No.: US 2009/0319339 A1
(43) Pub. Date: Dec. 24, 2009

(54) System for evaluating customer loyalty

(76) Inventor: Lal Chandra Singh, Pune (IN)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/456,795

(22) Filed: Jun. 23, 2009

(30) Foreign Application Priority Data
Jun. 24, 2008 (IN) 1319/MUM/2008

(51) Int. Cl. G06Q 10/00

(52) U.S. Cl. 705/10

(57) ABSTRACT

The present invention discloses a system and a method for evaluating customer loyalty. The system evaluates customer loyalty by calculating a satisfaction rating which is based on the customers' initial perception and actual experience of buying a product and/or service.

### CROSS-REFERENCE TO RELATED APPLICATION

The present application claims priority under 35 USC 119 of Indian Patent Application 1319/MUM/2008 filed Jun. 24, 2008, the entire disclosure of which is incorporated herein by reference.

### FIELD OF INVENTION

The invention relates to the field of conducting surveys for evaluation of customer satisfaction.

### DEFINITIONS OF TERMS USED IN THE SPECIFICATION

Cost: Costs do not necessarily comprise only of monetary cost but also comprise the psychological, emotional, or ethical needs of a customer.
Experience: Customer experience is a function of the anticipated expectation a buyer has before going through the whole buying process. The experience determines whether the customer feels happy, satisfied, delighted or disgusted.
Pre Feedback: Feedback received from the customers before commencement of the buying process.
Post Feedback: Feedback received from the customers after purchasing the product and/or service.
Stimulation: Stimulation is to induce a potential customer to buy a product and/or service. Particularly, to provoke the psychological, emotional, safety, health, security, biological and other needs that are lying latent, to the fore, so that the buyer assigns value and buys a product or service.
Satisfaction: Satisfaction is a function of the expectations that have been set by the seller before the acquisition of the product or service.
Value: Creating or assigning an importance or worth for a product and/or service in a potential customers mind by emerging the psychological, emotional, safety, health, security, biological and the like needs that are lying latent in the potential buyer and persuading him/her to buy the product and/or service.

### BACKGROUND OF THE INVENTION AND PRIOR ART

Customer satisfaction index is a measure of the customer's satisfaction in relation to a product/service in accordance with his pre-conceived notion about said product/service. Typically, it measures how products and services supplied by a company meet or surpass customer expectation or fall below thereto. In a world with a plethora of products and services, cut-throat competition ensues amongst one service provider to another, each vying for customer attention and warranting customer-satisfaction in return.

Accurate judgment of customer satisfaction from a service provider's point-of-view defines the service provider's stay in the market and his long-term sustainability. Customer satisfaction is thus, a key element in chalking of business strategy and a key differentiator amongst fellow competitors.

Engaging a customer's attention and safeguarding his interests in terms of product/service satisfaction entails a huge expenditure for a service/product providing entity. Customer relationship encompasses not only the product, service, after-sales service offered by the seller but also the experience attached during and after sales. A seamless flow beginning from enticing the customer to processing the customer's requests to delivering said service/product to the customer ensures a high satisfaction quotient. The psychology of availing of or of buying and selling concludes that the satisfaction itself is a function of expectations that have been set by the seller before the acquisition of the product or the service.

Ideally, the challenge to a seller lies in stimulating the prospective buyer to a degree wherein he makes the right kind and amount of promises in order to excite him and then to ‘sell’ the service/product and actually deliver more than what the buyer expected and anticipated. This closes the loop for further prospective availing of/buying and selling deals and ensures a come-back from the buyer.

US Patent Application 20070025535 describes a quality evaluation system for measuring and improving customer satisfaction at automated customer service centers'. It typically relies on identification of one or more dialogs between the customer and the service centre; said dialogs are those which may cause customer satisfaction issues. This system is not adapted to cater to customer outlook as well as business outlook in relation to the service value and cost value of a service/product.

U.S. Pat. No. 5,734,890 describes a system and method for analyzing procurement decision and customer satisfaction. The system and method for analysis is based typically on factual data of the business/vendor, and not on perceived value or experience in relation to the customer. The system in accordance with U.S. Pat. No. 5,734,890 provides a decision tool which requires selection between at least two alternatives. This system does not comprehensively evaluate the service-quotient and cost-quotient in relation to a product/service.

US Patent Application 20090125320 discloses a system for displaying information about business and their corresponding overall customer satisfaction index (CSI) score. The CSI score is calculated based on the customer satisfaction information collected via the telephone, email or web based survey. The CSI is supplemented with a timestamp to let a potential customer know how recent the CSI score is. However, the calculated CSI score is based purely on the customer feedback; if for e.g. 80% of the customers give a good feedback then CSI for the business is 80%. The system in accordance with US Patent application 20090125320 does not take into account the experience undergone by a customer in relation to the product/service and the cost of the product/service relating to a particular business.

Conventional customer satisfaction surveys that are conducted by either companies themselves or by independent institutions invariably capture the superficial and on-the-moment mindset of the customer without ever attempting to dig out either facets of the promised experience nor the insights into what the customer is really looking to get in the future, thus making it impossible to predict the future course of action of the customer.

There is a need for a system providing an accurate prediction model and an accurate behavior gauging model.

### OBJECT OF THE INVENTION

An object of this invention is to provide a system to gauge customer satisfaction in relation to a service or a product.

Another object of the present invention is to provide a system which evaluates customer satisfaction by taking into account the experience undergone by a customer in relation to the product/service.

Still another object of the present invention is to provide a system which evaluates the service-quotient and cost-quotient in relation to a product/service.

Yet another object of the present invention is to provide a system which predicts the future course of action of the customer by taking into account the promised experience and needs of the customers in the near future.

### SUMMARY OF THE INVENTION

The present invention envisages a system for evaluating customer loyalty. In accordance with an embodiment of the present invention said system comprises the following components:
at least one memory bank means adapted to store a bank of questionnaires containing plurality of questions;
a selection means for selecting the questionnaires from the memory bank;
a user interface adapted to display the selection and further adapted to receive user ratings for the questionnaire;
a feedback database adapted to store the received user rating along with the customer's demographic details;
a score calculating means adapted to receive the user rating from said feedback database and further adapted to read the user rating and provide weighted mathematical values;
a first calculating means adapted to receive said weighted mathematical values from the score calculating means and further adapted to calculate a stimulation index;
a second calculating means adapted to receive said weighted mathematical values from the score calculating means and further adapted to calculate a experiential index;
a satisfaction rating means adapted to receive inputs from said first calculating means and said second calculating means and further adapted to calculate a mathematical rated value as measured by said experimental index calculated by second calculating means against stimulation index calculated by said first calculating means; and
a report generation means adapted to receive the mathematical rated value and further adapted to generate a graphical representation of the customer feedback.

In accordance with another embodiment of the present invention, said system comprises a tool which converts raw data of questions based on ‘value’ and ‘cost’ to populate the questionnaires.

In accordance with still another embodiment of the present invention, the score calculating means receives the user ratings and generates mathematically weighted final measures namely perceived value, perceived cost, experienced value, and experienced cost.

In accordance with yet another embodiment of the present invention, said first calculating means calculates a simulation index by weighted mathematical value of perceived value against weighted mathematical value of perceived cost. And the second calculating means calculates an experiential index by weighted mathematical value of experienced value against weighted mathematical value of experienced cost.

In accordance with still another embodiment of the present invention, said report generating means has a tool which converts the calculated mathematical rated value into graphical representation and presents the graphical representation based on demographic details including gender, age, location, income, marital status, grade, education and the like.

In accordance with yet another embodiment of the present invention, said system includes an editing means for amending the questions stored in the memory bank.

In accordance with the present invention, there is provided a method for evaluating customer loyalty, said method comprising the following steps:
creating a memory bank for storing a bank of questionnaires containing plurality of questions;
creating the questions for the questionnaire;
storing the questionnaires in the memory bank;
selecting the questionnaires from the memory bank;
displaying the questionnaires to the customer;
receiving the customers' rating for the questionnaire;
storing the rating along with the customer's details;
calculating a weighted mathematical value from the received customer rating;
calculating a stimulation index from said weighted mathematical value;
calculating an experiential index from said weighted mathematical value;
calculating a satisfaction rating means by said experimental index against stimulation index; and
receiving the satisfaction rating and generating a report based on the graphical representation of satisfaction rating.

In accordance with one aspect of the present invention, the step of creating a memory bank storing a plurality of questionnaires includes the step of adding questions related to ‘cost’ and ‘value’.

In accordance with another aspect of the present invention, the step of receiving customer's rating includes the step of receiving customers rating for the ‘value’ and ‘cost’ related questions along with their demographic details.

In accordance with still another aspect of the present invention, the step of receiving customer's rating includes assigning a mathematically weighted value to the questions in the questionnaire and generating final measures namely perceived value, perceived cost, experienced value, and experienced cost.

In accordance with yet another aspect of the present invention, the step of calculating the stimulated index includes receiving the final measure of perceived value and perceived cost and further calculating the stimulation index as a ratio of perceived value against perceived cost.

In accordance with still another aspect of the present invention, the step of calculating the experiential index includes receiving the final measure of experienced value and experienced cost and further calculating the experiential index as a ratio of experienced value against experienced cost.

In accordance with yet another aspect of the present invention, the step of calculating the satisfaction rating includes calculating the satisfaction rating as a ratio of experiential index upon stimulation index.

In accordance with still another aspect of the present invention, the step of generating the report includes the step of converting the mathematical value of the satisfaction rating into a graphical representation.

### BRIEF DESCRIPTION OF THE FIGURES

Other aspects of the invention will become apparent by consideration of the accompanying drawings and their description stated below, which are merely illustrative of a preferred embodiment of the invention and do not limit in any way the nature and scope of the invention.

FIG. 1 illustrates a schematic of the customer loyalty evaluation system;

FIG. 2 illustrates a sample questionnaire hosted by said memory bank means, which is to be filled by a customer at the end of the delivery process and at regular intervals and relates to experienced service value of the product/service;

FIG. 3 illustrates a sample questionnaire hosted by said memory bank means, which is to be filled by a customer at the end of the delivery process and at regular intervals and relates to experienced cost value of the product/service;

FIG. 4 illustrates a sample questionnaire hosted by said memory bank means, which is to be filled by a customer just after the buying decision has been made and relates to expected service value of the product/service;

FIG. 5 illustrates a sample questionnaire hosted by said memory bank means, which is to be filled by a customer just after the buying decision has been made and relates to expected cost value of the product/service;

FIG. 6 illustrates a sample questionnaire hosted by said memory bank means, which is to be filled by a business at the end of the delivery process and at regular intervals and relates to experienced service value of the product/service;

FIG. 7 illustrates a sample questionnaire hosted by said memory bank means, which is to be filled by a business at the end of the delivery process and at regular intervals and relates to experienced cost value of the product/service;

FIG. 8 illustrates a sample questionnaire hosted by said memory bank means, which is to be filled by a business just after the buying decision has been made and relates to expected service value of the product/service;

FIG. 9 illustrates a sample questionnaire hosted by said memory bank means, which is to be filled by a business just after the buying decision has been made and relates to expected cost value of the product/service;

FIG. 10 and FIG. 11 illustrate a sample questionnaire and sample result respectively showing the use of the customer loyalty evaluation system for gauging employee satisfaction; and

FIG. 12 is a flowchart for the customer loyalty evaluation system.

### DETAILED DESCRIPTION

The present invention envisages a system for evaluating customer satisfaction and loyalty. The system analyzes customer satisfaction for a particular product and/or service and derives a Customer Satisfaction Index (CSI) which provides the service providers/vendors/companies with a proactive and predictive index to weigh the customer satisfaction and, over a period of time, determine the customer loyalty.

According to one aspect of the present invention, the customer loyalty evaluation system, unlike the conventional systems, takes customer feedback by preparing questionnaires having questions based on ‘value’ and ‘cost’. The feedback received in response to the questions based on ‘value’ and ‘cost’ give an accurate insight on the customer satisfaction. The present invention focuses on the customer's anticipated level of service/functionality of the product before buying the service and/or product and the experienced level of the service/functionality of the product after buying the service and/or product.

According to another aspect of the present invention, questionnaires are specially designed based on all kinds of needs and/or desires and their intensities in order to capture the mindset of a customer before and after the buying process. These questionnaires can be suitably adopted for a specific industry. Extreme value perceptions and extreme painful experiences of the customers are also captured as a part of the proposed questionnaire.

According to yet another aspect of the present invention, companies and/or vendors can create their accounts with the customer loyalty evaluation system. Once the account is created, the details of the company and the domains associated with the company can be managed by using the present invention. While creating the account, the companies need to provide mandatory details including their name as it will appear on the survey questionnaire, email address, postal address, contact numbers and a brief description about the company. In addition to these mandatory details the companies can optionally provide details which will assist the present invention in configuring the questionnaire layout page to give it a customized look and feel. These optional details include the company's mission statement, the company logo, selection of background color for the questionnaire and the company's corporate color scheme. On creation of the account, the companies can preview their selection and make changes as per their choice.

According to still another embodiment of the present invention, companies can configure the questionnaire based on their domain and/or products and/or services offered to the customers. While adding a survey the company admin gets various options for setting up the survey. The addition of a new survey takes place in three steps namely ‘Add Survey Details’, ‘Add Value Questions’ and ‘Add Costs Questions’. While adding survey details a company admin needs to provide mandatory information including the name of the survey, the engagement type namely ‘Business to Customer’ or ‘Business to Business’, the Start and End date of the survey, and the Survey type (Full survey, Pre or Post purchase surveys). Optionally, the admin can provide details like the business unit of the company which is conducting the survey, disproportionate value, a brief description of the survey, name of the product/service for which the survey is being carried out and the gap period. The present invention provides the admin with the provision of adding the value and cost related questions for the product/service. Moreover, the present invention enables the admin to configure label headings including heading for demographic data, value and cost based questions heading, and attribute heading details like very low, low, moderate, high, very high, disproportionately high, pre form description and post form description. Along with the above, admin's can customize the color scheme of the feedback form and also send an email invitation using the present invention.

According to yet another aspect of the present invention, once the survey is configured, the feedback on the products and/or services from customers can be generated using two modes namely ‘web-based application’ which provides direct access to the customers and 'collecting the feedback manually' which assigns customer executives for collecting feedback from customers. Specifically, the customers can be invited for participating in the survey by sending emails containing the questionnaire that lists the various questions. The present invention enables an admin user to maintain an address book which can be looked up for adding the email addresses of the participants. Along with the address book, the present invention gives the provisions like assigning a survey executive to the survey, managing the participants and starting the survey. After the response is received from the customers, provision for generating various customer feedback reports is also provided by the present invention.

According to still another aspect of the present invention, the pre and post feedback ratings which are received from the customers are given to a score calculation means which uses a tool to assign weighted values to each of the ratings and arrive at mathematical weighted values and gives final measures like perceived cost, which is derived from cost based questions of pre feedback form; perceived value, which is derived from value based questions of pre feedback form; experienced cost, which is derived from cost based questions of post feedback form; and experienced value, which is derived from cost based questions of post feedback form.

Typically, the selling process can be identified in two distinct parts: ‘preparing the stimulation’ and ‘making the experience happen’. Preparing the stimulation includes stimulating the latent needs of the customers to the fore and creating a value for the product in their minds. Stimulation takes place before the product and/or service is purchased. The Stimulation Index (SI) is calculated by dividing the perceived value by perceived cost. The intent to buy is directly proportional to the value of SI. It is postulated that no buying will take place unless SI is more than 1. Making the experience happen includes the experiences of the customers during the buying process individually or collectively. Experience takes place after the product and/or service is purchased by the customers. The Experiential Index (EI) is calculated by dividing the experienced value by experienced cost.

According to yet another aspect of the present invention, buying is a function of the relative value perceptions stimulated by the seller against the buyer's capacity and his resulting mindset. The ratio of the EI upon SI is a good measure for capturing customer satisfaction index (CSI). The higher the CSI the happier is the customer. Customer delight is directly proportional to the value of CSI. Over a continuous period, post the sales process, if CSI remains high, the customers develop a sense of Loyalty. On the other hand, if CSI keeps falling, the customer is likely to abandon his/her staidness at some time, and move away to another vendor. Thus, the CSI becomes an index which proactive and predictive in the business context and delivers measured value, both to sellers and buyers.

In accordance with one embodiment of the present invention, the customer loyalty evaluation system can be operated in two modes namely Admin and SuperAdmin. In the Admin mode, administrator can add a new survey, add value and cost related questions to the survey for calculation of the CSI. In the SuperAdmin mode, the super administrator can add new a new company or edit/update details of an existing company and add or manage users of a company, and assign permissions to the users.

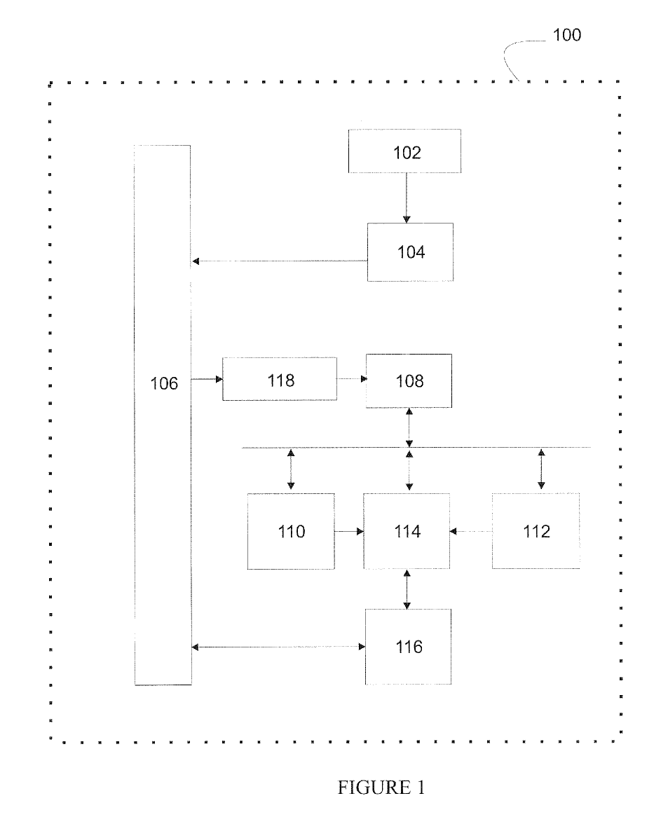

Referring to the accompanying drawings, FIG. 1 shows a schematic of the customer loyalty system, represented by block 100 of FIG. 1. In accordance with another embodiment of this invention, there is provided a memory bank means, represented by block 102 of FIG. 1 adapted to store a bank of questionnaires containing a plurality of questions. The questions are comprehensively designed to prompt rating of user need, user experience, business need, business experience and the like parameters.

In accordance with yet another embodiment of the present invention, there is provided a selection means, represented by block 104 of FIG. 1, which assists the administrator of the system to select the questions specific to the company's domain and further import these questions to the survey and provide it to the user interface, represented by block 106 of FIG. 1. In addition, the admin can add custom questions based on ‘value’ and ‘cost’ for importing into the survey. The system includes a tool which converts this raw data of questions into the questionnaire and further stores it in the memory bank means 102. Also, the system includes an editing means (not shown in the figures) for amending the questions stored in the memory bank means 102.

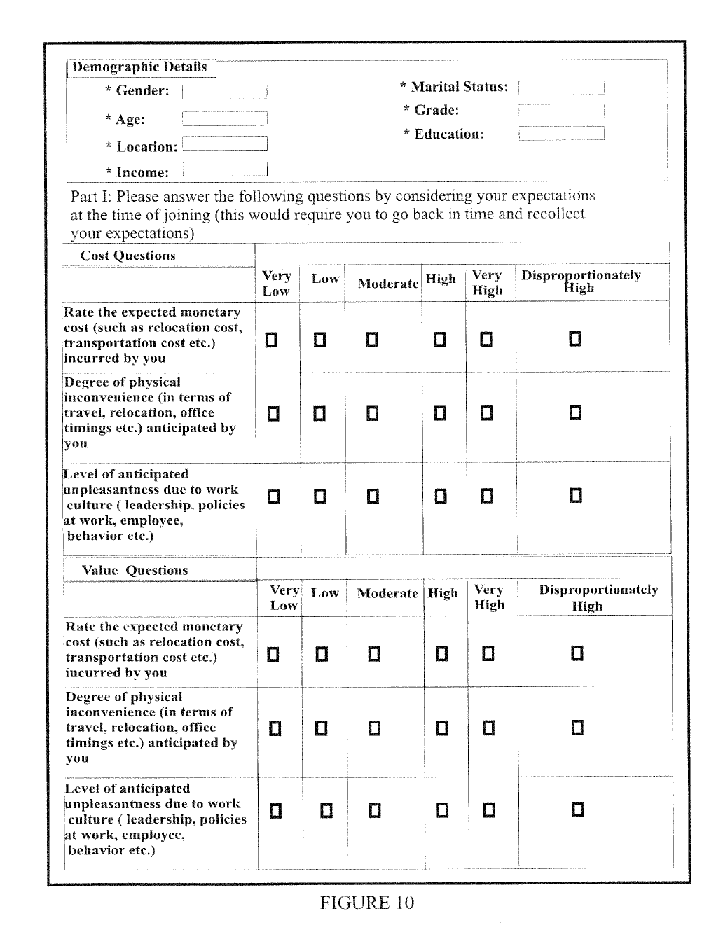

In accordance with still another embodiment of the present invention, the survey can be sent to the customers by email, i.e. by inviting a set of customers to the survey or by assigning a customer service executive who will be responsible for collecting the customer response for the survey. Typically, the invitation email will contain a link which once activated will connect to the user interface 106, the user interface 106 will then open the respective survey page. The survey page requests the customer to fill in the mandatory demographic details including gender, age, location, income, marital status, grade, education and the like before filing the survey. FIG. 10 shows a typical survey form in accordance with the present invention. The survey form as can be seen in FIG. 10 is divided into three sections namely demographic details, cost questions and value questions. The customers respond to the cost and value questions by rating their experiences as ‘very low’, ‘low’, ‘moderate’, ‘high’, ‘very high’ and ‘disproportionately high’.

In accordance with still another aspect of the present invention, the survey is conducted at regular intervals before and after the process of buying the product and/or service. A full survey includes questionnaires for pre and post feedback. Alternatively, partial surveys can be conducted which either capture the pre or the post feedback. The survey can be held for engagement types ‘Business to Customer’ and ‘Business to Business’.

The customer feedback is received by the user interface 106 and stored with the customers' details in a feedback database, represented by block 118 of FIG. 1. The feedback database 118, is further equipped with a score calculation means, represented by block 108 of FIG. 1, in accordance with a further embodiment of this invention. The score calculation means 108 is adapted to read said customer rating and provide a weighted mathematical value in accordance with the customer's magnitude of like or dislike. Typically, extreme value perceptions, extreme painful experiences, and the like may also be quantified in accordance with this embodiment. The entire range of feelings can hence be captured, quantified, and used for further scientific prediction and mathematical analyses. Typical final measures are perceived value, perceived cost, experienced value, and experienced cost.

In accordance with another embodiment of this invention, there is provided a first calculation means, represented by block 110 of FIG. 1, adapted to calculate stimulation index (SI) as a ratio of perceived cost and perceived value.

In accordance with this invention, the stimulation index is a measure of the stimulation required to induce a prospective buyer to avail of/buy a particular service/product, in that the seller needs to create a value of said service/product in the prospective buyer's mind.

This value is not necessarily only in monetary terms. It includes fulfilling psychological, emotional, safety, health, security, biological, and the like needs that are inherently present and sought after by the prospective buyer. While creating the stimulation, it is important to typically provoke some of these needs that may be lying latent, to the fore, so that the prospective buyer assigns a value and avails of/buys the service/product.

The overall value, thus perceived is continually weighed against parameters of the pre-conceived notion, such as ‘cost’ of a service/product. It is important to note that, just like perceived values, all costs are not monetary. For the purposes of this specification, ‘costs’ also extend to include experiences which are psychological, emotional, or ethical. The psyche measures all the parameters relating to a negative experience such as disruptions, inconveniences, and pains whilst availing of a service/product in relation to anticipated parameters.

In accordance with this invention, mathematical SI is a measure of the mathematical weighted value of the perceived value against the mathematical weighted value of the perceived cost.

$$S I = \frac{Perceived Value}{Perceived Cost}$$

The intent to buy is directly proportional to the value of the Stimulation Index. It is postulated that “no buying” would take place unless SI is more than 1.

In accordance with another embodiment of this invention, there is provided a second calculation means, represented by block 112 of FIG. 1, adapted to calculate Experiential Index (EI).

In accordance with this invention, Experiential Index is a measure of the experience undergone by a buyer/customer/business in relation to the service and cost of the product/service. During the buying process, a buyer may undergo the buying experience individually or collectively. This experience revalidates the anticipated value accruals as also the “real-costs” associated with the process.

In accordance with this invention, mathematical EI is a measure of the mathematical weighted value of the experienced value against the mathematical weighted value of the experienced cost.

$$E I = \frac{Experienced Value}{Experienced Cost}$$

The indices; stimulation index (SI) and experiential index (EI), have been designed to capture the relative value or cost perceptions by buyers as against absolute values.

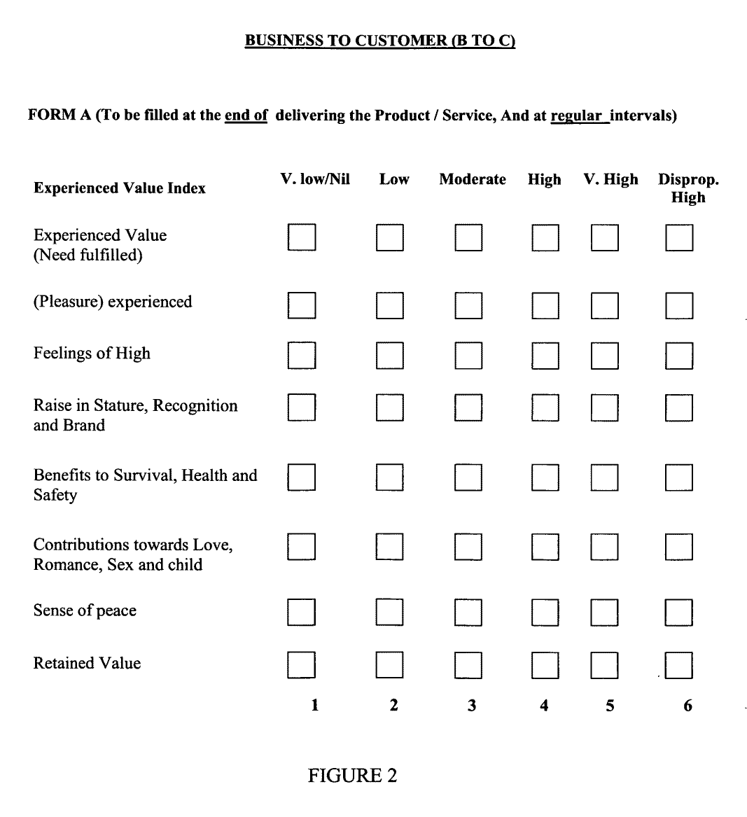

FIG. 2 illustrates a sample questionnaire hosted by said memory bank means 102, which is to be filled by a customer at the end of the delivery process and at regular intervals and relates to experienced service value of the product/service. A host of questions relating towards gauging and calculating the experience towards value of the service/product are provided to the customer. The customer evaluates the experience and rates the experience on a scale from 1 to 6 (with 1 as the lowest and 6 as the highest), typically in the form of very low experienced value, low experienced value, moderate experienced value, high experienced value, very high experienced value, disproportionately high experienced value, and the like. Each value is provided with a pre-determined mathematical weight which is recorded and utilized by said score reading means, said first calculating means 110, and said second calculating means 112.

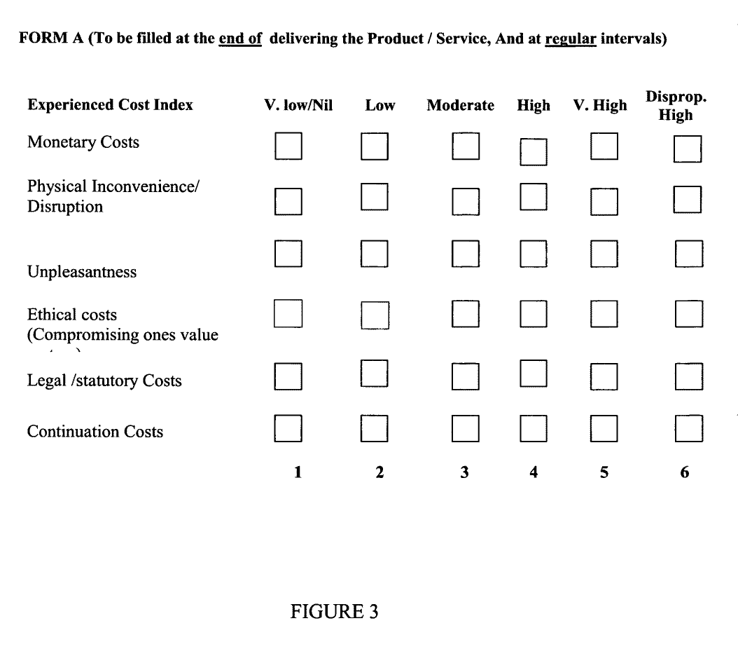

FIG. 3 illustrates a sample questionnaire hosted by said memory bank means 102, which is to be filled by a customer at the end of the delivery process and at regular intervals and relates to experienced cost value of the product/service. A host of questions relating towards gauging and calculating the experience towards cost of the service/product are provided to the customer. The customer evaluates the experience and rates the experience on a scale from 1 to 6 (with 1 as the lowest and 6 as the highest), typically in the form of very low experienced cost, low experienced cost, moderate experienced cost, high experienced cost, very high experienced cost, disproportionately high experienced cost, and the like. Each cost index is provided with a pre-determined mathematical weight which is recorded and utilized by said score reading means 108, said first calculating means 110, and said second calculating means 112.

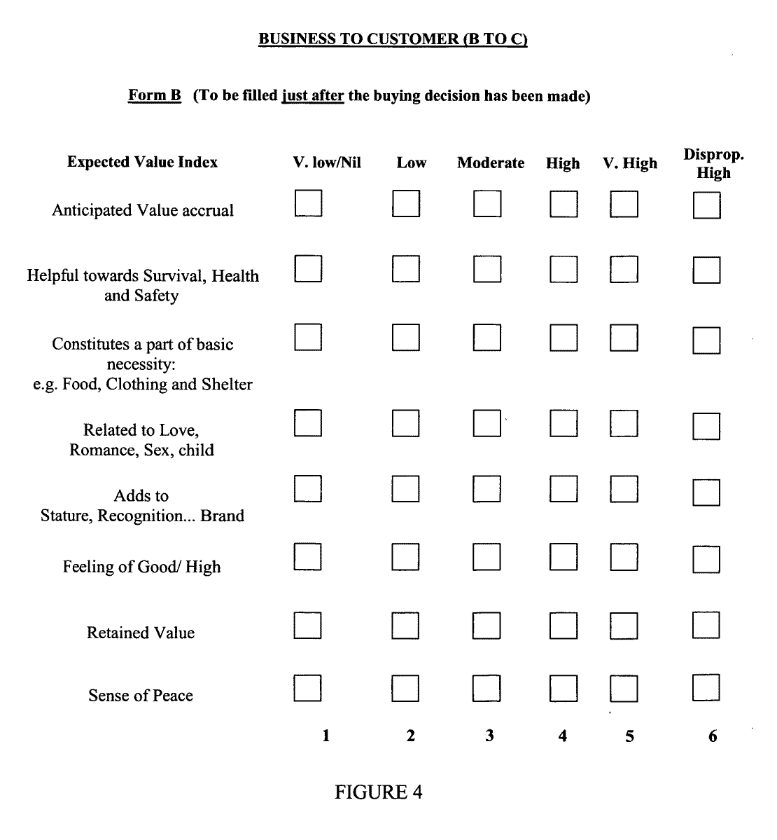

FIG. 4 illustrates a sample questionnaire hosted by said memory bank means, which is to be filled by a customer just after the buying decision has been made and relates to expected service value of the product/service. The customer evaluates the experience and rates the experience on a scale from 1 to 6 (with 1 as the lowest and 6 as the highest), typically in the form of very low experienced value, low experienced value, moderate experienced value, high experienced value, very high experienced value, disproportionately high experienced value, and the like. Each value is provided with a pre-determined mathematical weight which is recorded and utilized by said score reading means, said first calculating means, and said second calculating means.

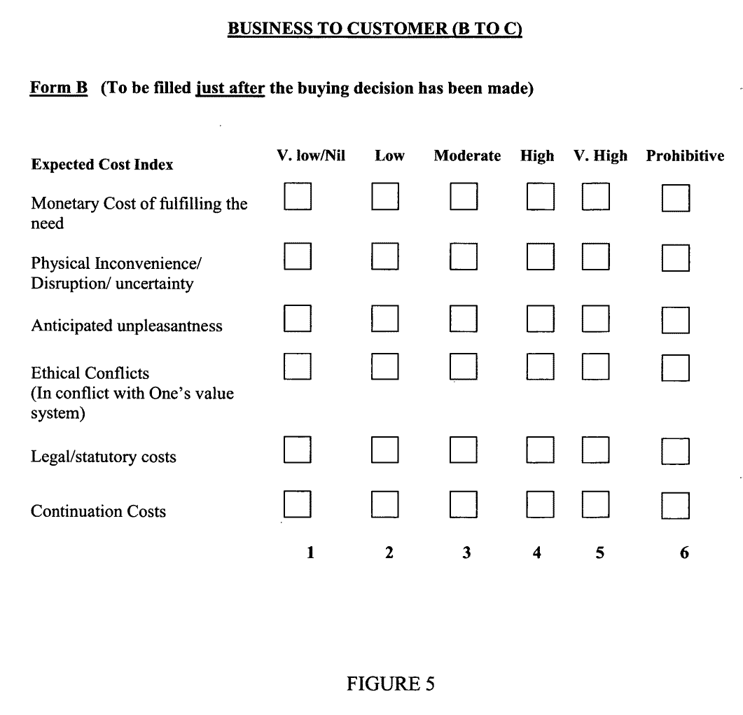

FIG. 5 illustrates a sample questionnaire hosted by said memory bank means 102, which is to be filled by a customer just after the buying decision has been made and relates to expected cost value of the product/service. The customer evaluates the experience and rates the experience on a scale from 1 to 6 (with 1 as the lowest and 6 as the highest), typically in the form of very low experienced cost, low experienced cost, moderate experienced cost, high experienced cost, very high experienced cost, disproportionately high experienced cost, and the like. Each cost index is provided with a pre-determined mathematical weight which is recorded and utilized by said score reading means 108, said first calculating means 110, and said second calculating means 112.

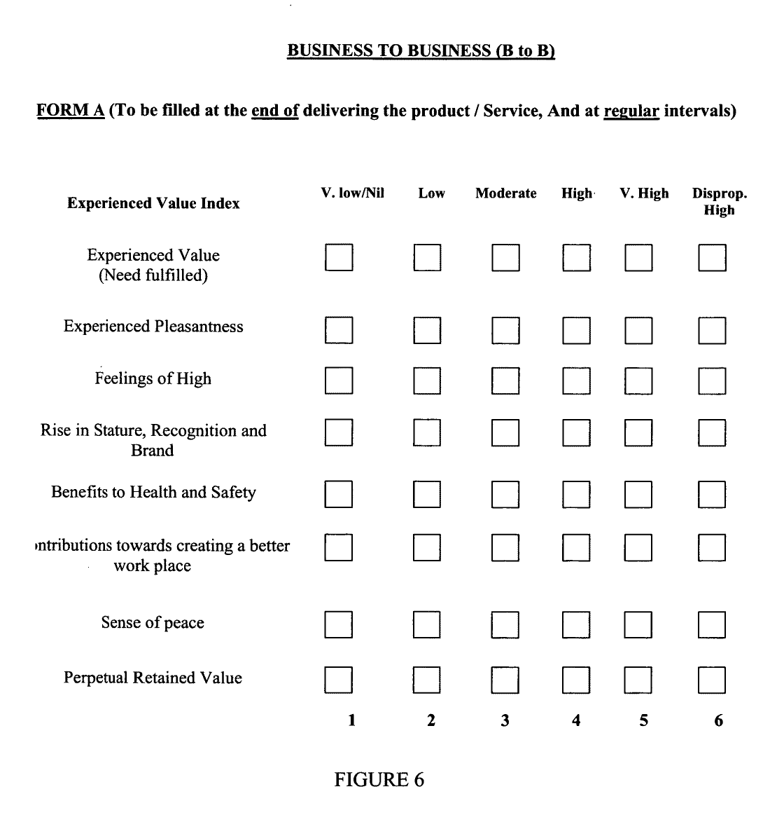

FIG. 6 illustrates a sample questionnaire hosted by said memory bank means 102, which is to be filled by a business at the end of the delivery process and at regular intervals and relates to experienced service value of the product/service. A host of questions relating towards gauging and calculating the experience towards value of the service/product are provided to the business. The business evaluates the experience and rates the experience on a scale from 1 to 6 (with 1 as the lowest and 6 as the highest), typically in the form of very low experienced value, low experienced value, moderate experienced value, high experienced value, very high experienced value, disproportionately high experienced value, and the like. Each value is provided with a pre-determined mathematical weight which is recorded and utilized by said score reading means 108, said first calculating means 110, and said second calculating means 112.

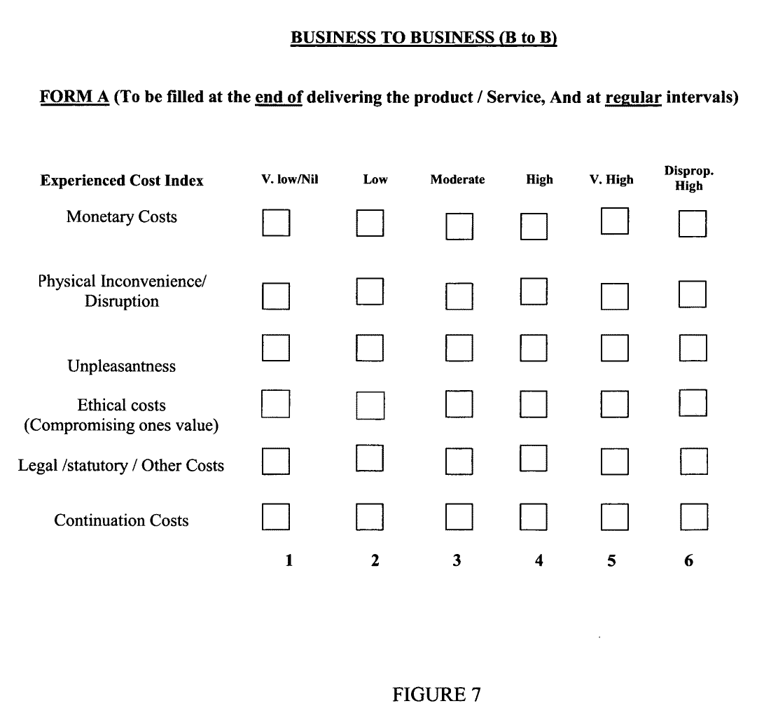

FIG. 7 illustrates a sample questionnaire hosted by said memory bank means 102, which is to be filled by a business at the end of the delivery process and at regular intervals and relates to experienced cost value of the product/service. A host of questions relating towards gauging and calculating the experience towards cost of the service/product are provided to the business. The business evaluates the experience and rates the experience on a scale from 1 to 6 (with 1 as the lowest and 6 as the highest), typically in the form of very low experienced cost, low experienced cost, moderate experienced cost, high experienced cost, very high experienced cost, disproportionately high experienced cost, and the like. Each cost index is provided with a pre-determined mathematical weight which is recorded and utilized by said score reading means 108, said first calculating means 110, and said second calculating means 112.

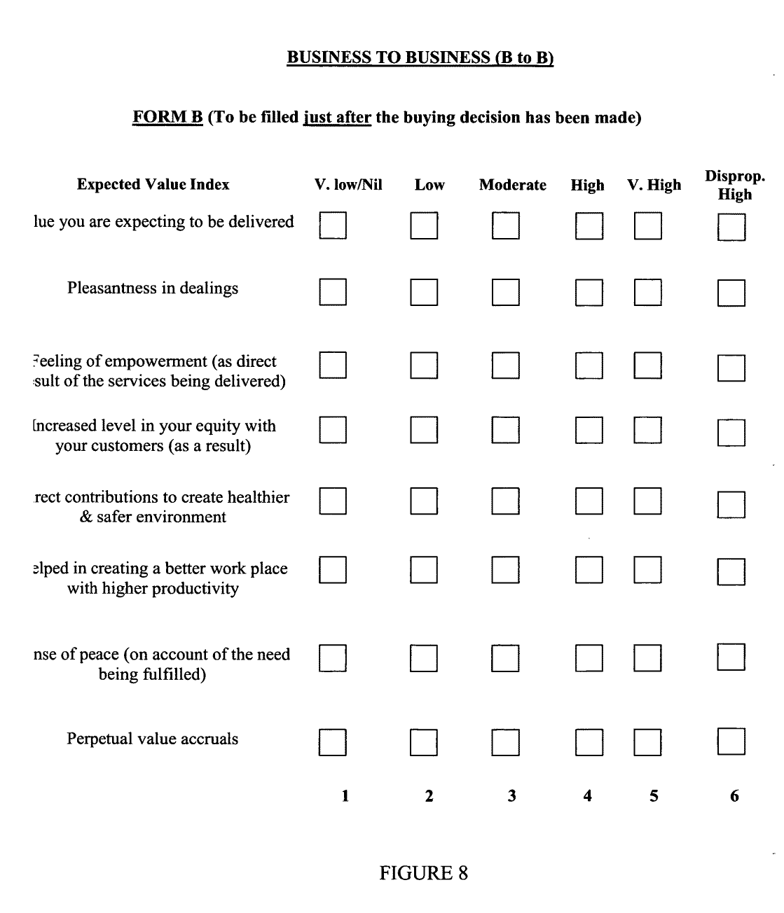

FIG. 8 illustrates a sample questionnaire hosted by said memory bank means 102, which is to be filled by a business just after the buying decision has been made and relates to expected service value of the product/service. The business evaluates the experience and rates the experience on a scale from 1 to 6 (with 1 as the lowest and 6 as the highest), typically in the form of very low experienced value, low experienced value, moderate experienced value, high experienced value, very high experienced value, disproportionately high experienced value, and the like. Each value is provided with a pre-determined mathematical weight which is recorded and utilized by said score reading means 108, said first calculating means 110, and said second calculating means 112.

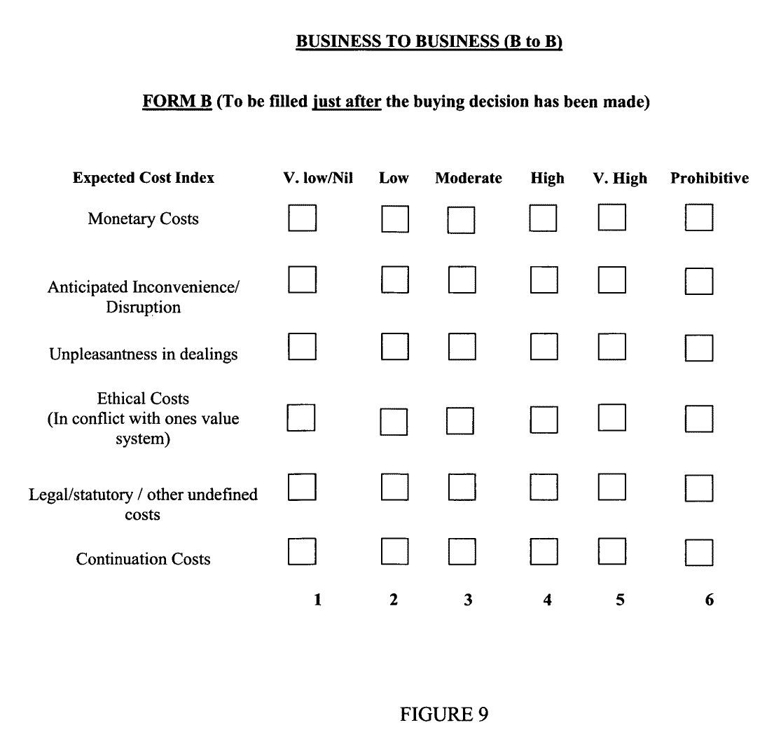

FIG. 9 illustrates a sample questionnaire hosted by said memory bank means 102, which is to be filled by a business just after the buying decision has been made and relates to expected cost value of the product/service. The business evaluates the experience and rates the experience on a scale from 1 to 6 (with 1 as the lowest and 6 as the highest), typically in the form of very low experienced cost, low experienced cost, moderate experienced cost, high experienced cost, very high experienced cost, disproportionately high experienced cost, and the like. Each cost index is provided with a pre-determined mathematical weight which is recorded and utilized by said score reading means 108, said first calculating means 110, and said second calculating means 112.

In accordance with still another embodiment of this invention, there is provided a satisfaction rating means, represented by block 114 of FIG. 1 adapted to receive inputs from the first calculating means 110 and the second calculating means 112 and calculate a mathematical rated value as measured by the experiential index calculated by the second calculating means 112 against the stimulation index calculated by the first calculation means 110.

$$Typically , Satisfaction rating = \frac{Experiential Index ( E I )}{Stimulation Index ( S I )}$$

This satisfaction rating thus becomes an index which is proactive and predictive in the business context, and delivers measured value, both to sellers and buyers.

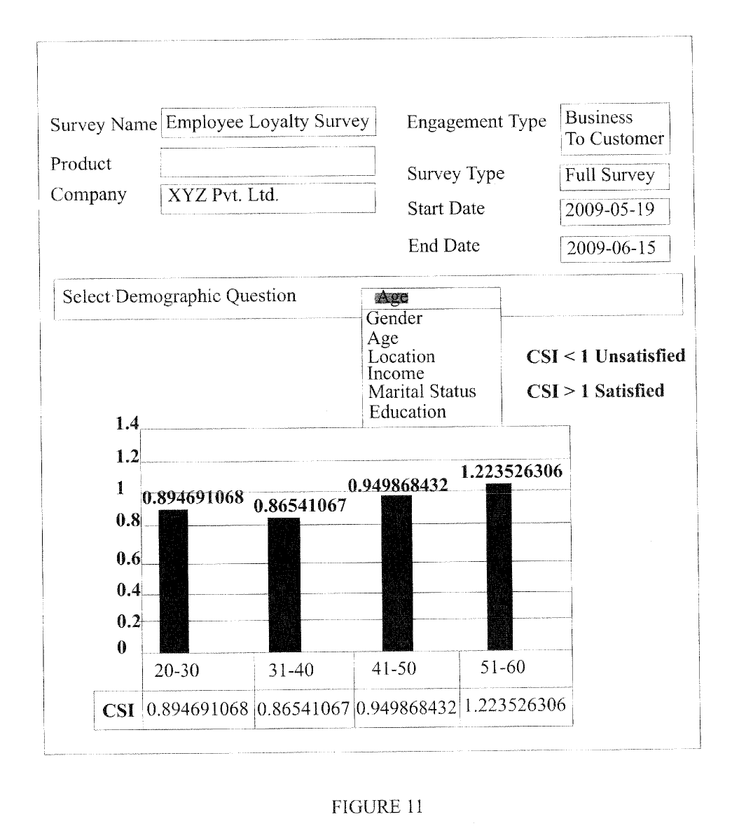

In accordance with yet another embodiment of the present invention, the satisfaction rating means 114 provides the satisfaction rating to a report generating means 116. The report generating means has a tool which converts the calculated satisfaction rating into graphical representation and presents the rating in different views based on demographic details including gender, age, location, income, marital status, grade, education and the like which were collected from the customer. FIG. 11 shows a typical output of the customer loyalty evaluation system. A CSI (Customer Satisfaction Index) of greater than one indicates to the organizations that the customers are satisfied with the product and/or service whereas CSI less than one indicates that the customer is unsatisfied. The report gives the users flexibility to view the results based on demographic details of the participants (customers who took the survey).

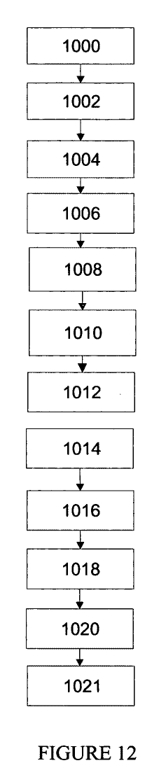

FIG. 12 is a flowchart showing the steps to be followed for evaluating customer loyalty in accordance with the present invention:

creating a memory bank for storing a bank of questionnaires containing plurality of questions, represented by block 1000 of FIG. 12;
creating the questions for the questionnaire, represented by block 1002 of FIG. 12;
storing the questionnaires in the memory bank, represented by block 1004 of FIG. 12;
selecting the questionnaires from the memory bank, represented by block 1006 of FIG. 12;
displaying the questionnaires to the customer, represented by block 1008 of FIG. 12;
receiving the customers' rating for the questionnaire, represented by block 1010 of FIG. 12;
storing the rating along with the customer's details, represented by block 1012 of FIG. 12;
calculating a weighted mathematical value from the received customer rating, represented by block 1014 of FIG. 12;
calculating a stimulation index from said weighted mathematical value, represented by block 1016 of FIG. 12;
calculating an experiential index from said weighted mathematical value, represented by block 1018 of FIG. 12;
calculating a satisfaction rating means by said experimental index against stimulation index, represented by block 1020 of FIG. 12; and
receiving the satisfaction rating and generating a report based on the graphical representation of satisfaction rating, represented by block 1021 of FIG. 12.

In accordance with still another aspect of the present invention, the system for evaluating customer loyalty can be applied to various businesses or domains. For instance, in an organization the present invention can be applied to determine the employee satisfaction and loyalty, in a hospitality industry the present invention can be applied to determine the guest satisfaction and loyalty, in a retail outlet the present invention can be applied to determine customer satisfaction and delight, in a travel industry the present invention can be applied to determine passenger satisfaction and loyalty, in an educational institute the present invention can be applied to determine student and/or staff satisfaction and delight and the like. In the fore mentioned domains value and cost related questions help to accurately determine the anticipated experience by the potential users against the final experience after availing the services or using the product. The outcome of the survey indicates to the organizations the satisfaction index and helps them to take steps to fix the shortcomings and increase the satisfaction levels for customer retention.

### Technical Advantages

The technical advance of the system in accordance with this invention lies in the means adapted for identification of comprehensive measurable weighted parameters at various levels of the delivery of service/product process in a duplex mode; from a customer's point of view in relation to a product/service provided by a business as well as from a business' point of view in relation to a product/service provided to a customer. Means adapted in accordance with various embodiments of the invention include capturing these identified measurable weighted parameters. Further, means for accurate scientific analysis of the measured weighted parameters provide a satisfaction quotient and help improve a business and eventually result in greater customer satisfaction, which was hitherto unknown.

While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

I claim:

1. A system for evaluating customer loyalty, said system comprising:
at least one memory bank means adapted to store a bank of questionnaires containing plurality of questions;
a selection means for selecting the questionnaires from the memory bank;
a user interface adapted to display the selection and further adapted to receive user ratings for the questionnaire;
a feedback database adapted to store the received user rating along with the customer's demographic details;
a score calculating means adapted to receive the user rating from said feedback database and further adapted to read the user rating and provide a weighted mathematical value;
a first calculating means adapted to receive said weighted mathematical value from the score calculating means and further adapted to calculate a stimulation index;
a second calculating means adapted to receive said weighted mathematical value from the score calculating means and further adapted to calculate a experiential index;
a satisfaction rating means adapted to receive inputs from said first calculating means and said second calculating means and further adapted to calculate a mathematical rated value as measured by said experimental index calculated by second calculating means against stimulation index calculated by said first calculating means; and
a report generation means adapted to receive the mathematical rated value and further adapted to generate a graphical representation of the customer feedback.

2. A system as claimed in claim 1, wherein said system comprises a tool which converts raw data of questions related to value to populate the questionnaires.

3. A system as claimed in claim 1, wherein said system comprises a tool which converts raw data of questions related to cost to populate the questionnaires.

4. A system as claimed in claim 1, wherein said score calculating means receives the user ratings and generates mathematically weighted final measures namely perceived value, perceived cost, experienced value, and experienced cost

5. A system as claimed in claim 1, wherein said first calculating means calculates simulation index by weighted mathematical value of perceived value against weighted mathematical value of perceived cost.

6. A system as claimed in claim 1, wherein said second calculating means calculates experiential index by weighted mathematical value of experienced value against weighted mathematical value of experienced cost.

7. A system as claimed in claim 1, wherein said report generating means has a tool which converts the calculated mathematical rated value into graphical representation and presents the graphical representation based on demographic details including gender, age, location, income, marital status, grade, education and the like.

8. A system as claimed in claim 1, wherein said system includes an editing means for amending the questions stored in the memory bank.

9. A method for evaluating customer loyalty, said method comprising the following steps:
creating a memory bank for storing a bank of questionnaires containing plurality of questions;
creating the questions for the questionnaire;
storing the questionnaires in the memory bank;
selecting the questionnaires from the memory bank;
displaying the questionnaires to the customer;
receiving the customers' rating for the questionnaire;
storing the rating along with the customer's details;
calculating a weighted mathematical value from the received customer rating;
calculating a stimulation index from said weighted mathematical value;
calculating an experiential index from said weighted mathematical value;
calculating a mathematical rated value by said experimental index against stimulation index; and
receiving the satisfaction rating and generating a report based on the graphical representation of satisfaction rating.

10. A method as claimed in claim 9, wherein the step of creating a memory bank hosting a plurality of questionnaires includes the step of adding questions related to ‘cost’ and ‘value’.

11. A method as claimed in claim 9, wherein the step of receiving customer's rating includes the step of receiving customers rating for the ‘value’ and ‘cost’ related questions along with their demographic details.

12. A method as claimed in claim 9, wherein the step of receiving customer's rating includes assigning a mathematically weighted value to the questions in the questionnaire.

13. A method as claimed in claim 9, wherein the step of calculating a rated mathematical value includes generating final measures namely perceived value, perceived cost, experienced value, and experienced cost.

14. A method as claimed in claim 9, wherein the step of calculating the stimulated index includes receiving the final measure of perceived value and perceived cost and further calculating the stimulation index as a ratio of perceived value against perceived cost.

15. A method as claimed in claim 9, wherein the step of calculating the experiential index includes receiving the final measure of experienced value and experienced cost and further calculating the experiential index as a ratio of experienced value against experienced cost.

16. A method as claimed in claim 9, wherein the step of calculating the satisfaction rating includes calculating the satisfaction rating as a ratio of experiential index upon stimulation index.

17. A method as claimed in claim 9, wherein the step of generating the report includes the step of converting the mathematical rated value of the satisfaction rating into a graphical representation.
